(19) United States
(12) Patent Application Publication
(10) Pub. No.: US 2002/0041143 A1
(43) Pub. Date: Apr. 11, 2002

(54) Cathode-ray tube

(76) Inventors: Masanaga Tanaka, Kanagawa (JP); Takahiro Inoue, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 09/880,148

(22) Filed: Jun. 14, 2001

(30) Foreign Application Priority Data
Jun. 15, 2000 (JP) P2000-180100

(51) Int. Cl. H01J 29/10

(52) U.S. Cl. 313/461

(57) ABSTRACT

According to the present invention, in the cathode-ray tube comprising a plurality of electron guns, the distance between the color-selection mechanism and the fluorescent substance screen can be made proper and the respective color fluorescent layers of the color fluorescent screen can be regularly disposed with an equal interval. Accordingly, it will be possible to display an image of high quality. Moreover, the fluorescent screen can be manufactured with ease.

In the cathode-ray tube comprising a plurality of electron guns, in particularly, two electron guns, when its fluorescent screen shape is formed as a curved surface can be obtained, which the expressions 1, 2, and 3, an ideal curved surface shape so that the image of the high quality can be provided.

### BACKGROUND OF THE INVENTION

1. Field of the Invention

The present invention relates to a cathode-ray tube which comprises a plurality of electron guns and depicts a whole image by comprising a plurality of images. More particularly, the present invention relates to a shape of a panel inner surface of the cathode-ray tube.

2. Description of the Related Art

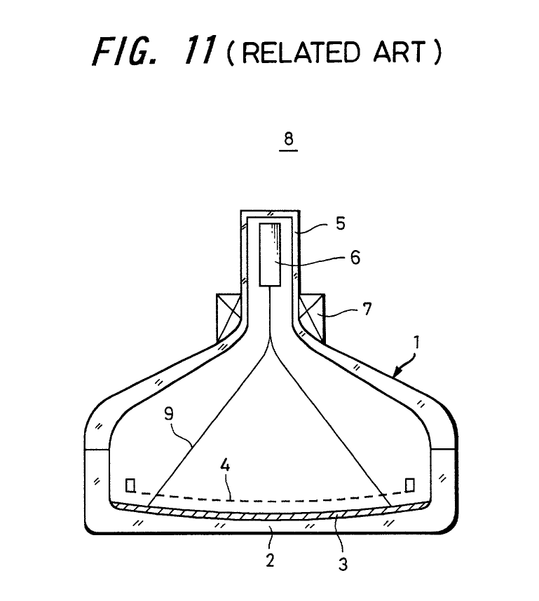

In a general color cathode-ray tube, as shown in FIG. 11, a color fluorescent screen 3 is formed on the inner surface of a panel 2 of a cathode-ray tube assembly 1. A color-selection mechanism 4 is disposed opposite to the color fluorescent screen 3 and an electron gun 6 is disposed within a neck portion 5. Further, a deflection yoke 7 is disposed outside the tube-assembly 1. In this cathode-ray tube 8, an electron beam 9 emitted from the electron gun 6 deflects its orbit by the deflection yoke 7, passes through the color-selection mechanism 4 and reaches to the fluorescent screen 3.

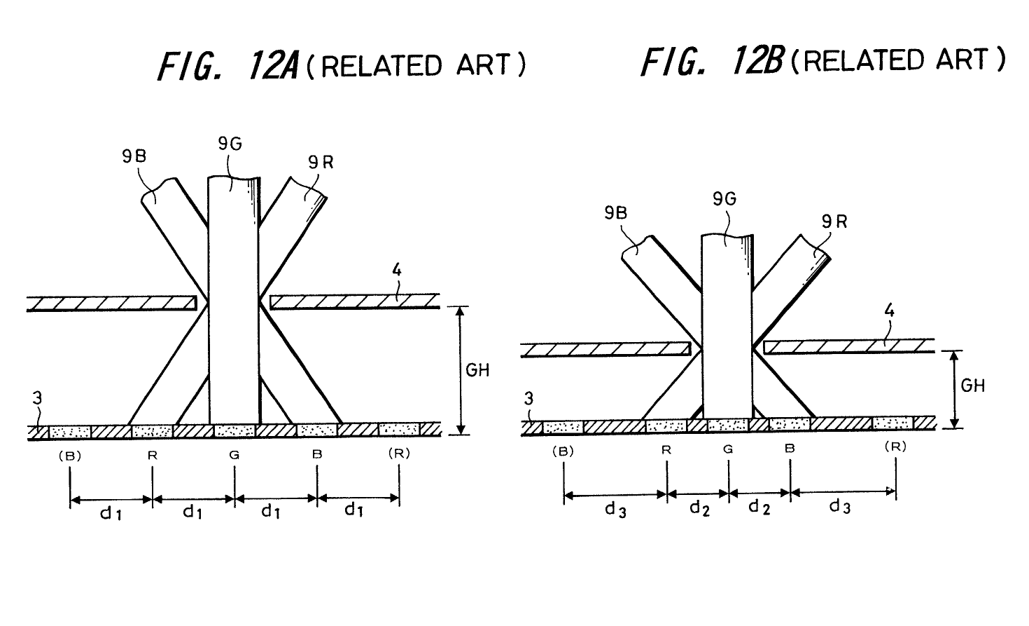

As shown in FIG. 12A, when a distance GH between (grill height) between the color-selection mechanism 4 and the fluorescent screen 3 is appropriate, the electron beams 9R, 9G, 9B which crosses on the color-selection mechanism 4 irradiate respective color fluorescent layers R, G and B which are arranged on the fluorescent screen 3 at uniform intervals of d₁.

However, when the distance GH between the color-selection mechanism 4 and the fluorescent screen 3 is inappropriate, as shown in FIG. 12B, the respective electron beams 9R, 9G, 9B which crosses on the color-selection mechanism 4 are not applied to the fluorescent screen 3 at the uniform intervals. Thus, where the fluorescent substance layers R, G and B form one trio an interval d₂ among the respective color fluorescent layers R, G and B within one trio, and an interval d₃ between the trios are different from each other.

If the electron beams 9 [9R, 9G, 9B] irradiate the fluorescent screen 3 at the uniform intervals of d₁, then the respective fluorescent substances R, G and B on the fluorescent screen 3 also can be arranged at the uniform intervals of d₁, so that the fluorescent screen 3 can be improved in quality.

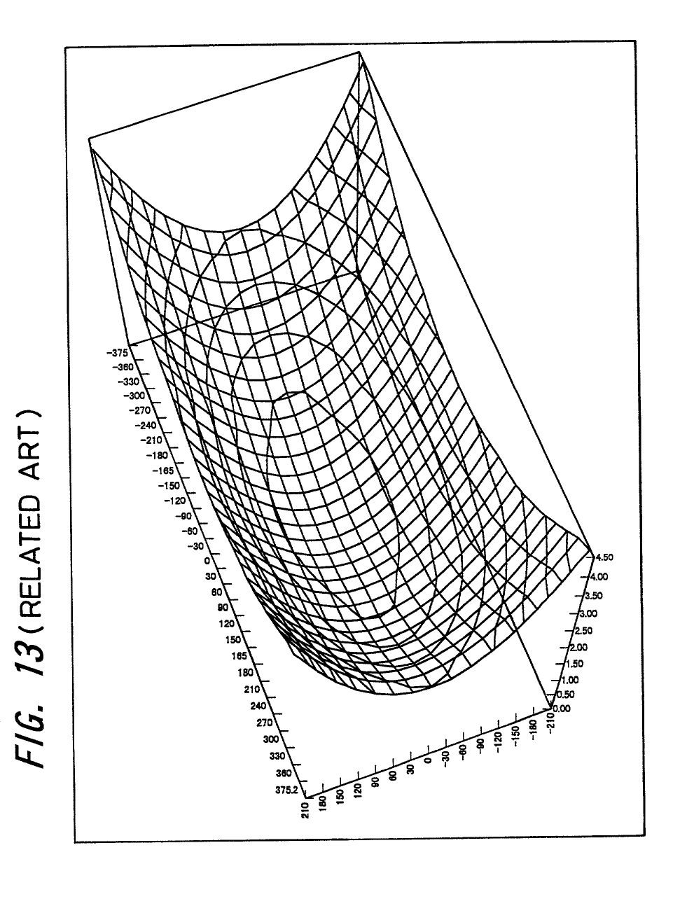

In a color cathode-ray tube having a single electron gun, the distance GH between the color-selection mechanism and the fluorescent screen has been made proper by variously defining the curved surface of the fluorescent screen. The fluorescent screen is generally shaped like a bottom of a bowl which is symmetrical in the vertical and horizontal directions with respect to the center of a screen forming the top. FIG. 13 shows a shape of a fluorescent screen of a color cathode-ray tube having a single electron gun obtained by simulation

On the other hand, as a cathode-ray tube which enables a large-screen, high-brightness and thin-type tube, there has been developed a large-sized cathode-ray tube having a plurality of electron guns, for example, two electron guns, in which a large image area is formed by comprising small image areas corresponding to the respective electron guns and in which a whole picture is depicted on this large image area. This cathode-ray tube having a plurality of electron guns must also have a proper shape of the fluorescent screen, namely, a proper shape of a panel inner surface should be made proper. However, there have not been provided this kind of cathode-ray tube of this type having a proper shape of the panel inner surface.

### SUMMARY OF THE INVENTION

In view of the aforesaid point, it is an object of the present invention aims to provide a cathode-ray tube, having a plurality of electron guns, in which a distance between a color-selection mechanism and a fluorescent screen can be made appropriate.

A cathode-ray tube according to the present invention comprises a plurality of electron guns and a panel inner surface which is formed as a plurality of bowl-like curved surfaces whose tops are points at which axes of a plurality of electron guns intersect the panel inner surface.

In the cathode-ray tube according to the present invention, because areas corresponding to the respective electron guns in the panel inner surface is formed as the bowl-like curved surfaces whose tops are the points at which the axes of the electron guns intersect the panel inner surface, the distance between the color-selection mechanism and the fluorescent screen can be made appropriate.

BRIEF DESCRIPTION OF THE DRAWINGS

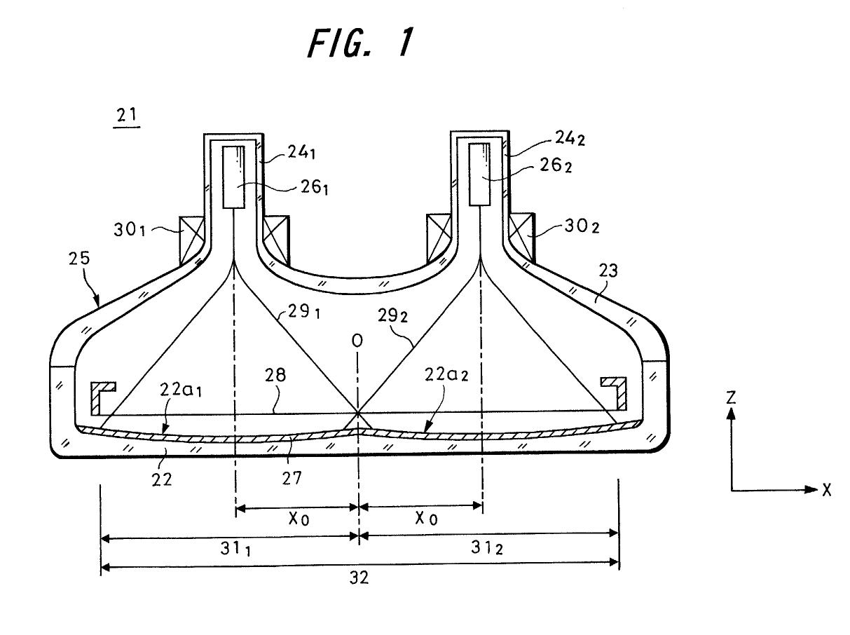

FIG. 1 is a structure diagram showing a cathode-ray tube according to an embodiment of the present invention;

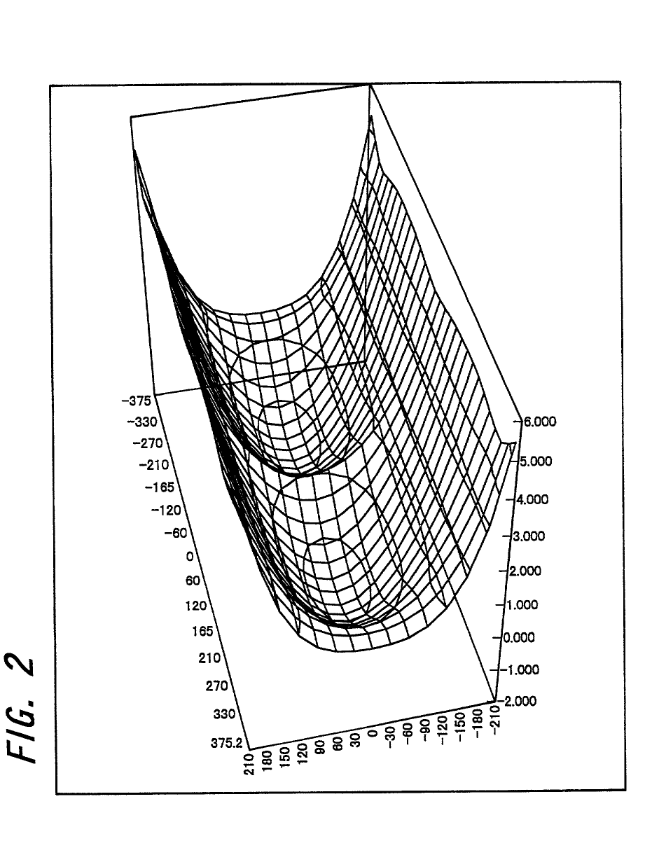

FIG. 2 is a simulation diagram showing an ideal shape of a fluorescent screen, i.e., a shape of a panel inner surface in a cathode-ray tube according to an embodiment of the present invention;

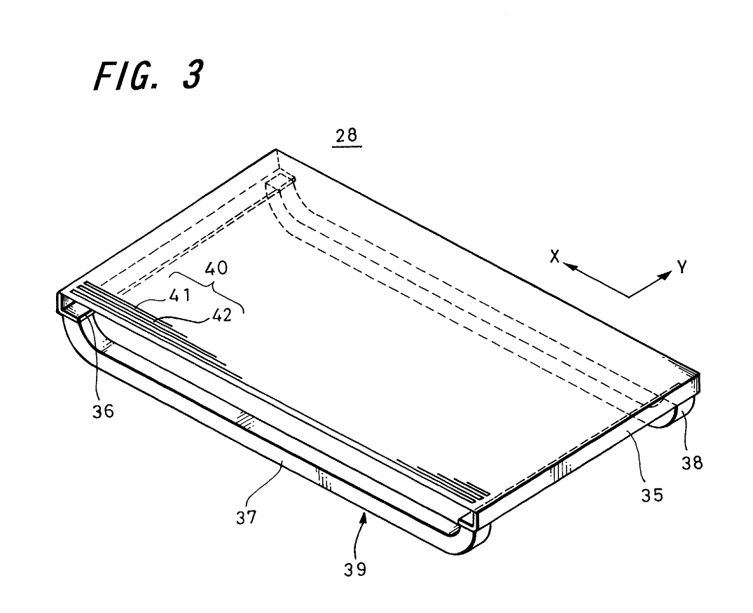

FIG. 3 is a structure diagram showing a color-selection mechanism for use in a cathode-ray tube according to an embodiment of the present invention;

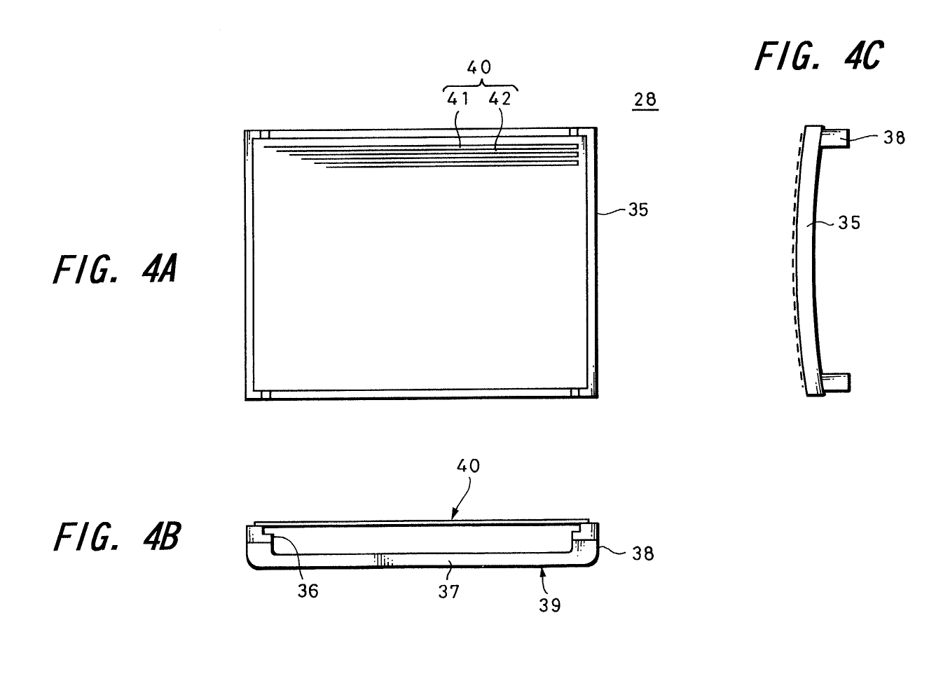

FIG. 4A is a front view of a color-selection mechanism according to the present invention;

FIG. 4B is a lower side view of the color-selection mechanism according to the present invention;

FIG. 4C is a right-hand side view of the color-selection mechanism according to the present invention;

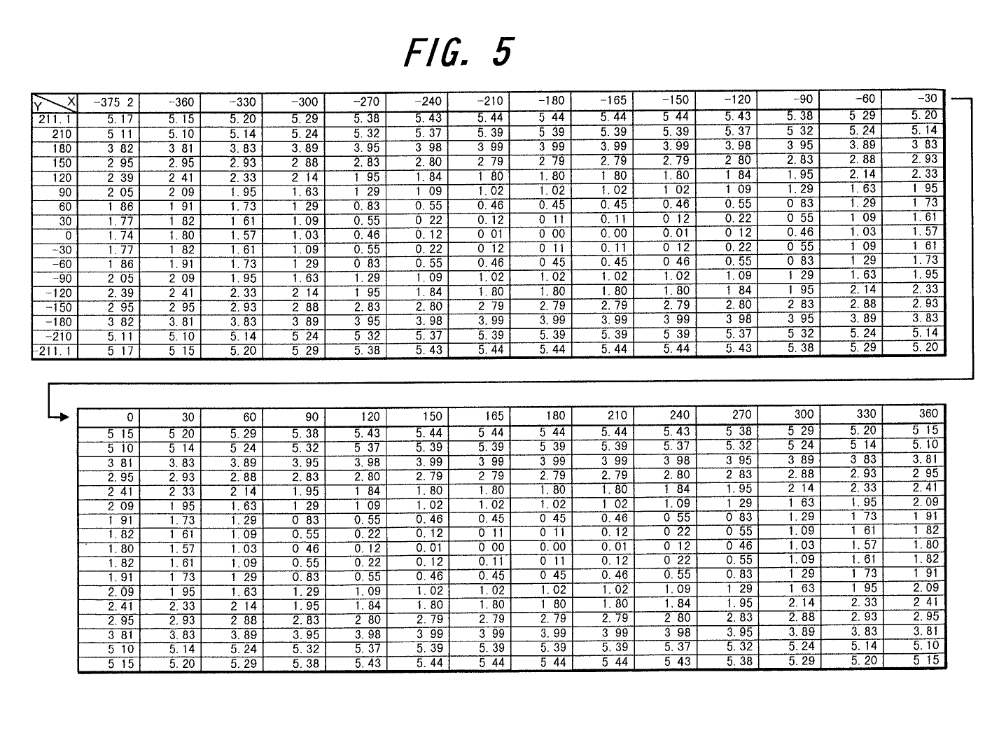

FIG. 5 is a table diagram showing Z values at respective positions obtained when a shape of a fluorescent screen of a 36-inch cathode-ray tube comprising two electron guns is set up using the expression 1;

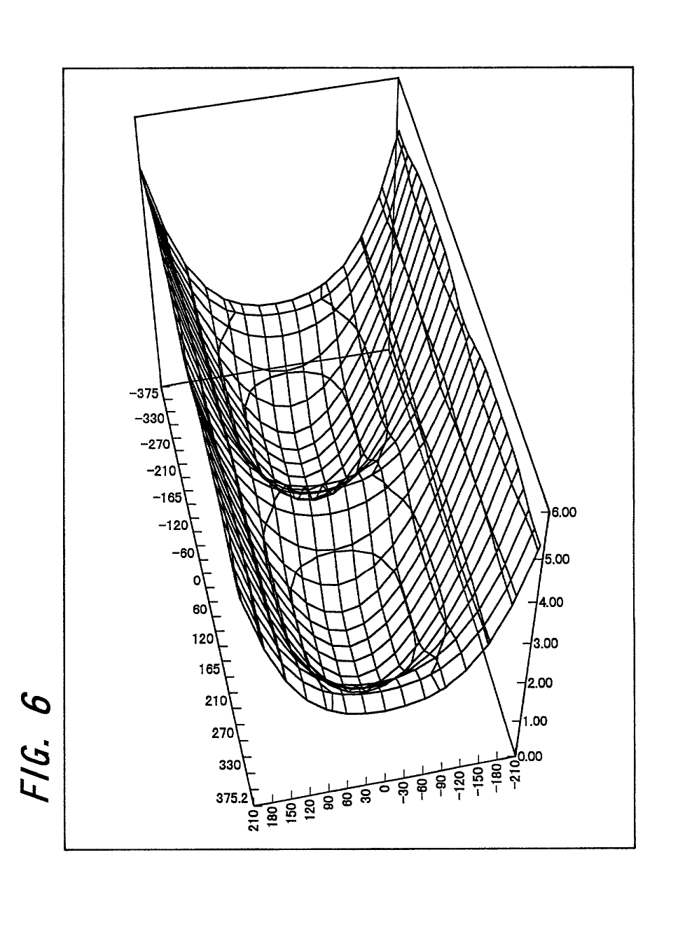

FIG. 6 is a simulation diagram of the shape of a fluorescent screen based on FIG. 5;

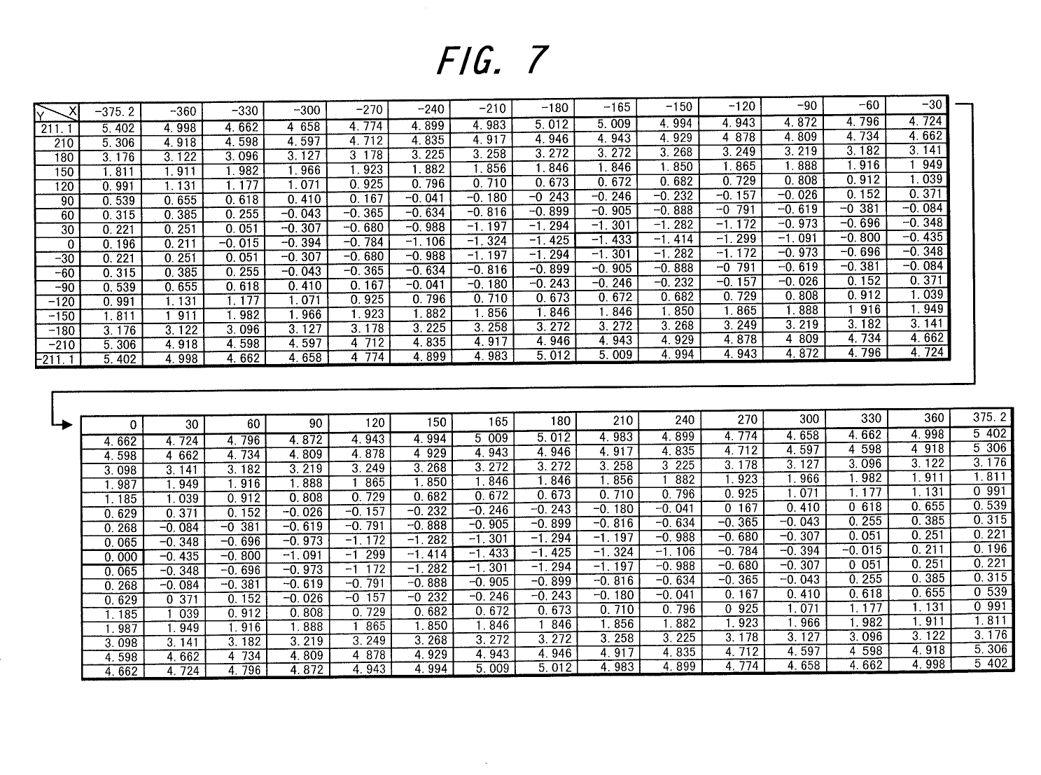

FIG. 7 is a table diagram showing Z values at respective positions obtained when a shape of a fluorescent screen of a 36-inch cathode-ray tube comprising two electron guns is set up using the expression 2;

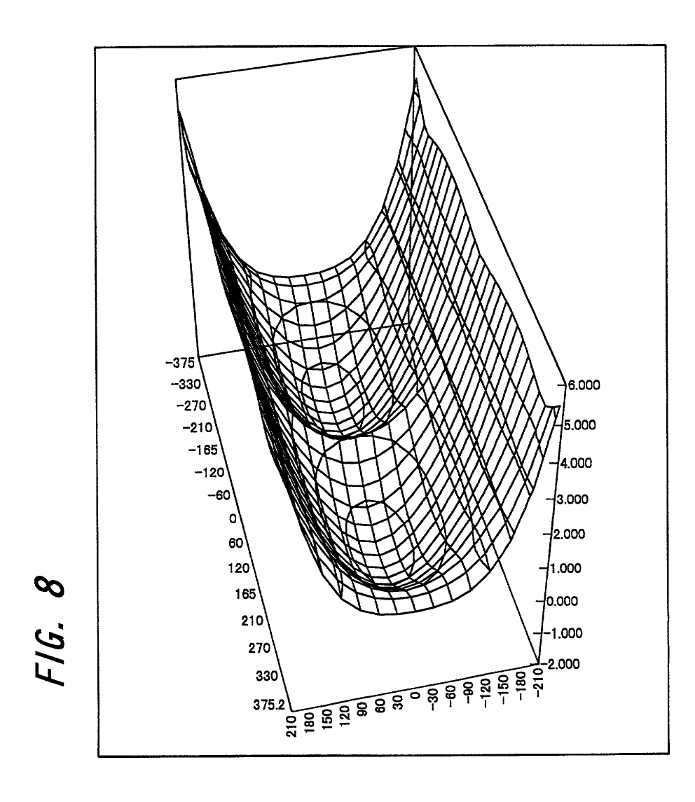

FIG. 8 is a simulation diagram of a shape of the fluorescent screen based on FIG. 7;

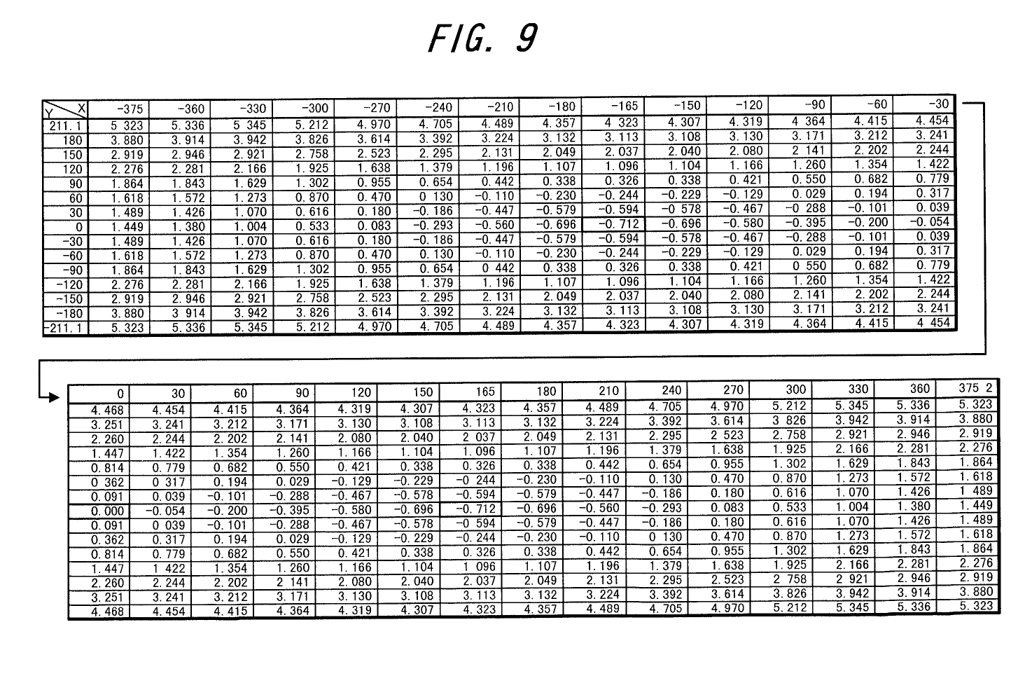

FIG. 9 is a table diagram showing Z values at respective positions obtained when a shape of a fluorescent screen of a 36-inch cathode-ray tube comprising two electron guns is set up using the expression 3;

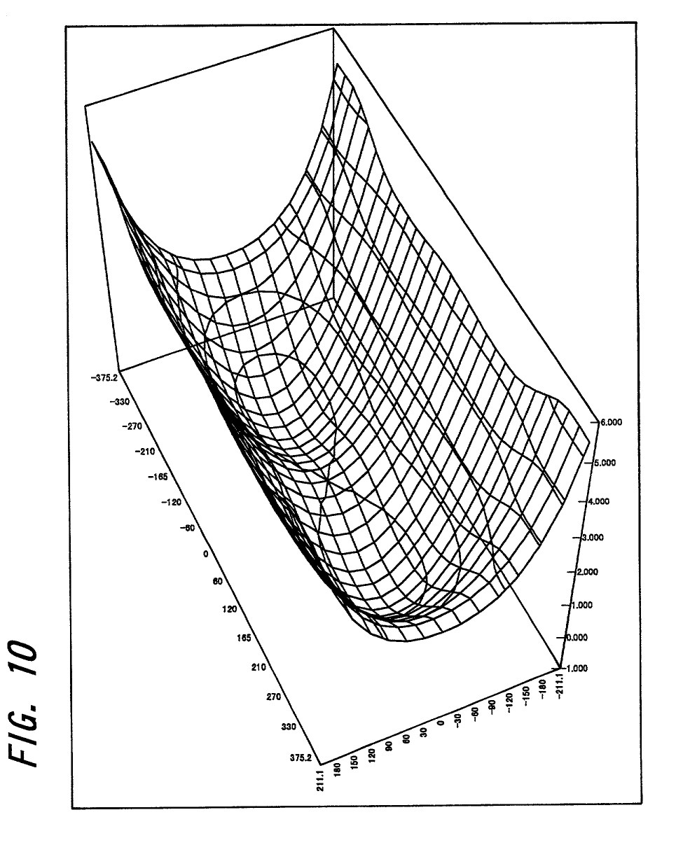

FIG. 10 is a simulation diagram of the shape of a fluorescent screen based on FIG. 9;

FIG. 11 is a structure diagram showing an ordinary color cathode-ray tube;

FIG. 12A is a diagram for explaining the case where a color-selection mechanism and a fluorescent screen have a proper distance GH therebetween;

FIG. 12B is a diagram for explaining the case where a color-selection mechanism and a fluorescent screen do not have a proper distance GH therebetween; and

FIG. 13 is a simulation diagram of a shape of a fluorescent screen of an ordinary color cathode-ray tube.

### DESCRIPTION OF THE PREFERRED EMBODIMENTS

A cathode-ray tube according to an embodiment of the present invention will be described below with reference to the drawings.

FIG. 1 shows a color cathode-ray tube according to an embodiment of the present invention.

A color cathode-ray tube 21 according to this embodiment comprises a plurality of electron guns, in this embodiment, two electron guns, and has a tube-body 25 including a panel 22 forming a large image area, a funnel 23 joined to this panel 22 and a plurality of necks, in this embodiment, two necks 24 [24₁, 24₂] joined to this funnel 23. Electron guns 26 [26₁, 26₂] are disposed within the respective necks 24 and a color-selection mechanism 28, e.g., an aperture grille, a shadowmask and the like is disposed in an opposing relation to a color fluorescent screen 27 formed on an inner surface of the panel 22 so that a whole image may be depicted on a large image area from synthesizing a plurality of small image areas. At the outside of the tube-body 25, deflection yokes 30 [30₁, 30₂] are disposed in a range of from the respective neck portions 24₁, 24₂ to the funnel portion.

The panel 22 is integrally formed into like an oblong shape whose major axis extends in the horizontal direction and whose minor axis extends in the vertical direction. On the inner surface of the panel 22 are formed a plurality of small image areas 31 corresponding to the number of the electron guns 26 which are scanned by electron beams emitted from the respective electron guns 26, whose number. In this embodiment, two small image areas 31₁, 31₂ are formed. A large image area 32 is formed by composing the two small image areas 31₁, 31₂.

In this embodiment, electron beams 29₁, 29₂ from the respective electron guns 26 are adapted to scan the respective small image areas 31₁, 31₂, so that they may partly overlap each other on the adjacent small image areas near the boundary between the two small image areas 31₁ and 31₂.

As shown in FIG. 3, the color-selection mechanism 28, in this embodiment, the aperture grille is constructed in such a manner that a color-selection electrode 40 is extended between supporting members 35 and 36 on a metal frame 39 comprised of a pair of opposite supporting members 35, 36 and elastic embers 37, 38 joined to the respective ends of the above supporting members. This color-selection electrode 40 includes, for example, a large number of ribbon-like grid elements (elongated in the horizontal direction of the screen) 42 arranged along the vertical direction of the screen and a large number of slit-like electron beam passing holes (elongated in the horizontal direction of the screen) 41 formed between the grid elements 42.

The color-selection electrode thin plate 40 and the frame 39 are joined together by welding, for example. This color-selection mechanism 28 is made common to the large image area 32 of the panel 22.

As shown in FIG. 4, the color-selection electrode 40 of the color-selection mechanism 28 is attached to the frame 39 in such a manner that the so-called grid elements 42 extends linearly in the extension direction, i.e., in the horizontal direction and is also forms a curved shape having a required curvature in the direction perpendicular to the extension direction, i.e., in the vertical direction.

In this embodiment, the electron beams 29₁, 29₂ from the electron guns 26₁, 26₂ are adapted to scan the screen in the vertical direction and also in the horizontal direction from the ends of the screen to the center of the screen and overlap each other near the center of the screen.

Particularly, in this embodiment, the shape of a fluorescent screen, i.e., an inner surface of the panel 22 is formed as a plurality of curved surfaces, in this embodiment, two bowl-like curved surfaces 22a₁, 22a₂ whose tops are the points at which respective axes of a plurality of electron guns 26 intersect the fluorescent screen 27, namely, the panel inner surface cross with each other. These curved surfaces 22a₁, 22a₂ integrally formed as a continuous inner surface of the panel.

In the case of a planar type cathode-ray tube, an outer surface of the panel 22 is formed as a flat surface.

In the cathode-ray tube 21 having the two electron guns 26₁, 26₂ shown in FIG. 1, the respective electron guns 26₁ and 26₂ emit the electron beams 29₁, 29₂ so that the respective electron beams may depict a picture of almost half of the screen, respectively. With respect to each of the electron beams 29₁, 29₂, the fluorescent screen shape, namely, the panel inner surface shape equivalent to that of the cathode-ray tube having a single electron gun may be considered to be optimum. Accordingly, in the cathode-ray tube comprising the two electron guns, it is proper to form the fluorescent screen of the whole large image area as two bowl-like curved surfaces having the two tops as shown in FIG. 1. FIG. 2 shows an ideal fluorescent screen shape obtained by simulation.

The following expression 1 shows an example of a formula which defines the fluorescent screen shape i.e., the panel inner surface shape of the cathode-ray tube 21 comprising the two electron guns 26₁, 26₂.

In this example, the center of the screen of the cathode-ray tube 21 comprising two electron guns is defined as the origin O, the major axis direction of the screen (horizontal axis in this embodiment) being defined as the X-axis, the minor axis of the screen (vertical axis in this embodiment) being defined as the Y-axis and an axis which is perpendicular top both the X-axis and Y-axis being defined as the Z-axis, respectively (see FIG. 1).

$$\begin{matrix}Z = C1 \cdot {[ 1 + cos ( X / X0 \cdot π ) ]}^{2} + \\ C2 \cdot {[ 1 + cos ( X / X0 \cdot π ) ]}^{4} + \\ C3 \cdot {Y}^{2} + \\ C4 \cdot {Y}^{4} + \\ C5 \cdot {[ 1 + cos ( X / X0 \cdot π ) ]}^{2} \cdot {Y}^{2} + \\ C6 \cdot {[ 1 + cos ( X / X0 \cdot π ) ]}^{2} \cdot {Y}^{4} + \\ C7 \cdot {[ 1 + cos ( X / X0 \cdot π ) ]}^{4} \cdot {Y}^{2} + \\ C8 \cdot {[ 1 + cos ( X / X0 \cdot π ) ]}^{4} \cdot {Y}^{4}\end{matrix} \qquad [ Expression 1 ]$$

where C1 to C8 are coefficients which depend on so-called tube types such as the size of a cathode-ray tube, the pitch of respective color fluorescent substance layers R, G, B of the fluorescent screen, intervals among the R, G, B beams at the deflection center, characteristics and positional relationship of the deflection yokes 30 [30₁, 30₂] and the electron guns 26 [26₁, 26₂] relative to the cathode-ray tube.

X0 represents a constant which depends on the position on the axis of the electron gun 26 (position of the top of the curved surface), i.e., the distance from the origin O to the position on the axis of the electron gun 26 (see FIG. 1). [0020]

If this definition formula of this expression 1 is used, then its differential value is a continuous function so that the curved surface can be set to a smooth once. The fluorescent screen shape in the cathode-ray tube 21 comprising the two electron guns 26, i.e., the inner surface shape of the panel 22 can be made proper by setting up the panel inner surface shape so as to satisfy the expression 1.

The following expression 2 shows another example of a formula which defines the fluorescent screen shape i.e., the panel inner surface shape of the cathode-ray tube 21 comprising the two electron guns 26₁, 26₂.

In this example also, the center of the screen of the cathode-ray tube including the two electron guns is defined as the origin O, the major axis of the screen (horizontal axis in this embodiment) being defined as the X-axis, the minor axis direction of the screen (vertical direction in this embodiment) being defined as the Y-axis and an axis which is perpendicular top both the X-axis and the Y-axis being defined as the Z-axis, respectively (see FIG. 1).

[Expression 2]

Z=(C1+C2Θ|X|+C3ΘX²+C4ΘX⁴+C5ΘX⁶+C6ΘX⁸)+(C7+C8Θ|X|+C9ΘX²+C10ΘX⁴+C11ΘX⁶+C12ΘX⁸)ΘY²+(C13+C14Θ|X|+C15ΘX²+C16ΘX⁴+C17ΘX⁶+C18ΘX⁸)ΘY⁴

where C1 to C18 are coefficients which depend on so-called tube types such as the size of a cathode-ray tube, the pitch of the respective color fluorescent substance layers R, G, B of the fluorescent screen, interval among the R, G, B beams at the deflection center, characteristics and positional relationship of the deflection yokes 30 [30₁, 30₂] and the electron guns 26 [26₁, 26₂] relative to the cathode-ray tube.

If the definition formula of this expression 2 is used, then the position of the top of the curved surface (position of X0 in FIG. 1) and the like can be set up freely, so that a target curved surface shape can be reproduced with a high accuracy by design.

The fluorescent screen shape in the cathode-ray tube 21 comprising the two electron guns 26, i.e., the inner surface shape of the panel 22 can be made proper by setting up the panel inner surface shape so as to satisfy the expression 2.

The following expression 3 shows a still another example of a formula which defines the fluorescent screen shape i.e., the panel inner surface shape of the cathode-ray tube 21 comprising the two electron guns 26₁, 26₂.

In this example also, the center of the screen of the cathode-ray tube 21 comprising two electron guns is defined as the origin O, the major axis of the screen (horizontal axis in this embodiment) is defined as an X-axis, the minor axis direction of the screen (vertical axis in this embodiment) being defined as the Y-axis and an axis which is perpendicular to both the X-axis and Y-axis being defined as the Z-axis, respectively (see FIG. 1).

$$\begin{matrix}Z = ( C1 + C2 \cdot {X}^{2} + C3 \cdot {X}^{4} + C4 \cdot {X}^{6} + C5 \cdot {X}^{8} + \\ C6 \cdot {X}^{10} ) ( C7 + C8 \cdot {X}^{2} + C9 \cdot {X}^{4} + C10 \cdot {X}^{6} + \\ C11 \cdot {X}^{8} + C12 \cdot {X}^{10} ) \cdot {Y}^{2} + ( C13 + C14 \cdot {X}^{2} + \\ C15 \cdot {X}^{4} + C16 \cdot {X}^{6} + C17 \cdot {X}^{8} + C18 \cdot {X}^{10} ) \cdot {Y}^{4}\end{matrix} \qquad ( Expression 3 ]$$

where C1 to C18 are coefficients which depend on so-called tube types such as the size of a cathode-ray tube, the pitch of the respective color fluorescent substance layers R, G, B of the fluorescent screen, intervals among the R, G, B beams at the deflection center, characteristics and positional relationship of the deflection yokes 30 [30₁, 30₂] and the electron guns 26 [26₁, 26₂] relative to the cathode-ray tube.

The definition formula of this expression 3 is a continuous function and can also define surfaces with high accuracy. It has, as it were, advantages of both the expressions 1 and 2.

The fluorescent screen shape in the cathode-ray tube 21 comprising two electron guns 26, i.e., the inner surface shape of the panel 22 can be made proper by setting up the panel inner surface shape so as to satisfy the expression 3.

FIG. 5 is a table diagram showing Z values of respective positions indicative of the fluorescent screen shape, i.e., the panel inner surface shape set up by the definition formula of the above expression 1 in a case where it is applied to a 36-inch type cathode-ray tube including two electron guns. In this table, numerical values are expressed in a millimeter and values of the coefficients C1 to C8 in the expression 1 are obtained as follows:

C1=4. 6944×10⁻¹

C2=−4. 9464×10⁻³

C3=1. 2628×10⁻⁴

C4=−9. 3393×10⁻¹¹

C5=−2. 6676×10⁻⁵

C6=3. 3217×10⁻¹⁰

C7=4. 4862×10⁻⁷

C8=−9. 1089×10⁻¹²

FIG. 6 shows the panel inner surface shape obtained by simulation based on the Z values in FIG. 5.

The fluorescent screen shape in the 36-inch type cathode-ray tube comprising the two electron guns can be made proper by setting up the panel inner surface shape so as to satisfy the expression 1.

FIG. 7 is a table diagram showing Z values of respective positions indicative of the fluorescent screen shape, i.e., the panel inner surface shape set up by the definition formula of the above expression 2 in a case where it is applied to a 36-inch type cathode-ray tube comprising two electron guns. In this table, numerical values are expressed in a millimeter unit and value of the coefficients C1 to C18 in the expression 2 are as follows:

C1=0. 0000×10⁺⁰⁰

C2=−1. 5643×10⁻²

C3=3. 7785×10⁻⁵

C4=1. 6809×10⁻¹⁰

C5=−1. 2087×10⁻¹⁶

C6=−5. 7252×10⁻²¹

C7=7. 1653×10⁻⁵

C8=8. 8499×10⁻⁷

C9=−2. 4738×10⁻⁹

C10=−5. 9268×10⁻¹⁵

C11=5.7234×10⁻²⁰

C12=−1. 8304×10⁻²⁵

C13=7. 3959×10⁻¹⁰

C14=−1. 1031×10⁻¹¹

C15=3. 9767×10⁻¹⁴

C16=−4. 6878×10⁻²⁰

C17=−1. 4234×10⁻²⁴

C18=1. 2078×10⁻²⁹

FIG. 8 shows the panel inner surface shape obtained by simulation based on the values in FIG. 7.

The fluorescent screen shape in the 36-inch type cathode-ray tube comprising the two electron guns can be made proper by setting up the panel inner surface shape so as to satisfy the expression 2.

FIG. 9 is a table diagram showing Z values of respective positions indicative of the fluorescent screen shape, i.e., the panel inner surface shape set up by the definition formula of the above expression 3 in a case it is applied to a 36-inch type cathode-ray tube comprising two electron guns. In this table, numerical values are expressed in a millimeter unit and values of the coefficients C1 to C18 in the expression 3 are as follows

C1=0. 0000×10⁺⁰⁰

C2=−6. 1424×10⁻⁵

C3=1. 6930×10⁻⁹

C4=−1. 6921×10⁻¹⁴

C5=9. 0706×10⁻²⁰

C6=−2. 1471×10⁻²⁵

C7=1. 0058×10⁻⁴

C8=2. 9384×10⁻⁹

C9=−9. 4919×10⁻¹⁴

C10=1. 2743×10⁻¹⁸

C11=−8. 5943×10⁻²⁴

C12=2. 2253×10⁻²⁹

C13=−7. 1702×10⁻¹²

C14=−4. 3111×10⁻¹⁴

C15=1. 4722×10⁻¹⁸

C16=−1. 9362×10⁻²³

C17=1. 2453×10⁻²⁸

C18=−3. 0768×10⁻³⁴

FIG. 10 shows the panel inner surface shape obtained by simulation based on the values in FIG. 9.

The fluorescent screen shape in the 36-inch type cathode-ray tube comprising the two electron guns can be made proper by setting up the panel inner surface shape so as to satisfy the expression 3.

While the cathode-ray tube comprising the two electron gun has been described so far in the above embodiment, the present invention is not limited thereto and can also be applied to a cathode-ray tube comprising three or more of electron guns.

According to the cathode-ray tube 21 of the above embodiment, the distance GH between the color-selection mechanism 28 and the color fluorescent screen 27 can be made proper, so that the respective color fluorescent substance layers R, G, B of the color fluorescent screen 27 can be disposed equal intervals Accordingly, it will be possible to display an image of high quality.

Moreover, according to this embodiment, the color fluorescent screen 27 can be manufactured with ease. In particular, as concerns the cathode-ray tube comprising two electron guns, the color fluorescent screen 27 can be manufactured more easily as compared with the case where the definition formulas (expressions 3 and 1) for determining the above fluorescent screen shapes are not used.

While, in the above embodiment, the present invention is applied to the cathode-ray tube comprising a plurality of electron guns in which electron beams from the respective electron guns irradiate the respective small image areas so that the electron beams may partly overlap each other on the adjacent small image areas near the boundaries between the respective small image areas of the panel inner surface the present invention is not limited thereto, and can also be applied to a cathode-ray tube in which electron beams from respective electron guns irradiate up to boundaries between respective small image areas of a panel inner surface so that electron beams may not overlap with each other on the adjacent small image areas.

According to the present invention, in the cathode-ray tube comprising a plurality of electron guns, the distance between the color-selection mechanism and the fluorescent substance screen can be made proper and the respective color fluorescent layers of the color fluorescent screen can be regularly disposed with an equal interval Accordingly, it will be possible to display an image of high quality. Moreover, the fluorescent screen can be manufactured with ease.

In the cathode-ray tube comprising a plurality of electron guns, in particularly, two electron guns, when its fluorescent screen shape is formed as a curved surface can be obtained, which the expressions 1, 2, and 3, an ideal curved surface shape so that the image of the high quality can be provided

When a color-selection mechanism including grid elements which extent linearly horizontal direction the straight line and are arranged to form a curved surface shape in the vertical direction is extended like the curved surface shape is disposed relative to the fluorescent screen shape according to the present invention described above, the distance between the color-selection mechanism and the fluorescent screen can be made proper.

The present invention is suitably applied to the cathode-ray tube having the structure in which electron beams from the respective electron guns irradiate the respective small image areas so that the electron beams may partly overlap between the respective small image areas of the pas near boundaries inner surface each other on the adjacent small image areas boundaries.

What is claimed is:

1. A cathode-ray tube comprising
a plurality of electron guns; and
a panel inner surface formed as a plurality of bowl-like curved surfaces whose tops are points at which respective axes of said plurality of electron guns intersect the panel inner surface cross each other.

2. A cathode-ray tube comprising:
two electron guns; and
a panel inner surface being formed as a curved surface which satisfies the following expression when the center of screen is defined as the origin, a screen major axis being defined as the X-axis, a screen minor axis being defined as the Y-axis and an axis perpendicular to both said X-axis and said Y-axis is defined as the Z-axis;
$$\begin{matrix}Z = {C1 [ 1 + cos ( X / X0 \cdot π ) ]}^{2} + \\ {C2 [ 1 + cos ( X / X0 \cdot π ) ]}^{4} + \\ C3 {Y}^{2} + \\ C4 {Y}^{4} + \\ {C5 [ 1 + cos ( X / X0 \cdot π ) ]}^{2} {Y}^{2} + \\ {C6 [ 1 + cos ( X / X0 \cdot π ) ]}^{2} {Y}^{4} + \\ {C7 [ 1 + cos ( X / X0 \cdot π ) ]}^{4} {Y}^{2} + \\ {C8 [ 1 + cos ( X / X0 \cdot π ) ]}^{4} {Y}^{4}\end{matrix}$$
(where C1 to C8 are coefficients which depend on tube types).

3. A cathode-ray tube comprising:
two electron guns; and
a panel inner surface formed as a curved surface which satisfies the following expression when the center of a screen is defined as the origin, a screen major axis being defined as the X-axis, a screen minor axis being defined as the Y-axis and an axis perpendicular to said X-axis and both Y-axis being defined as the Z-axis;
Z=(C1+C2|X|+C3 X²+C4 X⁴+C5 X⁶+C6 X⁸)+(C7+C8|X|+C9 X²+C10 X⁴+C11 X⁶+C12 X⁸)Y²+(C13+C14|X|+C15 X²+C16 X⁴+C17 X⁶+C18 X⁸)Y⁴
(where C1 to C18 coefficients which depend on tube types).

4. A cathode-ray tube comprising
two electron guns; and
a panel inner surface being formed as a curved surface which satisfies the following expression when the center of a screen is defined as the origin, a screen major axis direction is defined as the X-axis, a screen minor axis being defined as the Y-axis and an axis perpendicular to both said X-axis and Y-axis being defined as the Z-axis;
$$\begin{matrix}Z = ( C1 + C2 {X}^{2} + C3 {X}^{4} + C4 {X}^{6} + C5 {X}^{8} + C6 {X}^{10} ) + \\ ( C7 + C8 {X}^{2} + C9 {X}^{4} + C10 {X}^{6} + C11 {X}^{8} + C12 {X}^{10} ) {Y}^{2} + \\ ( C13 + C14 {X}^{2} + C15 {X}^{4} + C16 {X}^{6} + C17 {X}^{8} + C18 {X}^{10} ) {Y}^{4}\end{matrix}$$
(where C1 to C18 are coefficients which depend on tube types).

5. A cathode-ray tube according to claim 1, wherein electron beams from said respective electron guns irradiate adjacent small image so that they may partly overlap each other on the adjacent small image areas near boundaries between small image areas depicted by electron guns on said panel inner surface.

6. A cathode-ray tube according to claim 2, wherein electron beams from said respective electron guns are irradiated on adjacent small image areas so that they may partly overlap each other on the adjacent small image areas near a boundary between small image areas depicted by electron guns on said panel inner surface.

7. A cathode-ray tube according to claim 3, wherein electron beams from said respective electron guns irradiate on adjacent small image areas so that they may partly overlap each other on the adjacent small image areas near a boundary between small image areas depicted by electron guns on said panel inner surface.

8. A cathode-ray tube according to claim 4, wherein electron beams from said respective electron guns irradiated adjacent small image areas so that they may partly overlap each other on the adjacent small image areas near a boundary between small image areas depicted by electron guns on said panel inner surface.

9. A cathode-ray tube according to claim 1, wherein a color-selection mechanism is disposed opposite to said panel inner surface and said color-selection mechanism includes grid elements which extend linearly in the horizontal directions and are arranged to form a curved surface shape in the vertical directions.

10. A cathode-ray tube according to claim 2, wherein a color-selection mechanism is disposed opposite to said panel inner surface and said color-selection mechanism includes grid elements which extend linearly in the horizontal direction and are arranged to form a curved surface shape in the vertical directions.

11. A cathode-ray tube according to claim 3, wherein a color-selection mechanism is disposed opposite to said panel inner surface and said color-selection mechanism includes grid elements which extend linearly in the horizontal direction and are arranged to form a curved surface shape in the vertical directions are extended like curved surfaces.

12. A cathode-ray tube according to claim 4, wherein a color-selection mechanism is disposed opposite to said panel inner surface and said color-selection mechanism includes grid elements which extend linearly in the horizontal direction and are arranged to form a curved surface shape in the vertical direction.
